(19) United States
(12) Patent Application Publication
(10) Pub. No.: US 2021/0333644 A1
(43) Pub. Date: Oct. 28, 2021

(54) DISPLAY PANEL AND MANUFACTURING METHOD FOR DISPLAY PANEL

(71) Applicant: SHENZHEN CHINA STAR OPTOELECTRONICS TECHNOLOGY CO., LTD., Shenzhen, Guangdong (CN)

(72) Inventor: Kecheng XIE, Shenzhen, Guangdong (CN)

(21) Appl. No.: 16/608,523

(22) PCT Filed: Jun. 6, 2019
(86) PCT No.: PCT/CN2019/090237

§ 371 Date: Oct. 25, 2019

(30) Foreign Application Priority Data
May 21, 2019 (CN) 201910422590.X

(51) Int. Cl. G02F 1/1337; G02F 1/1339

(52) U.S. Cl. CPC G02F 1/133788; G02F 1/133723; G02F 1/1339

(57) ABSTRACT

A manufacturing method for a display panel that includes the following steps: a first substrate manufacturing step, a second substrate manufacturing step, an assembling step, and a first alignment film layer manufacturing step. The display panel includes a first substrate, a second substrate, a liquid crystal layer, and a sealant layer. The manufacturing method for the display panel disposes a first liquid crystal alignment monomer layer on a surface of a common electrode layer, and uses a heat gun to perform heat and light treatment to a color filter substrate to make a link reaction occur between the first liquid crystal alignment monomer layer and the common electrode layer and form a first alignment film layer, and thereby undesirable alignment is improved and greyscale difference of a display panel caused by undesirable alignment is avoided to ensure yields and quality of products.

### FIELD OF INVENTION

The present invention relates to the field of display, and especially to a display panel and a manufacturing method for the display panel.

### BACKGROUND OF INVENTION

With advantages such as a thin body, power saving, etc., liquid crystal displays (LCDs) have achieved a wide range of applications. LCDs in the market now are mostly backlight LCD panels, which include an LCD panel and a backlight module.

An LCD panel usually includes a thin film transistor (TFT) array substrate, a pixel electrode, a first polyimide (PI) alignment film, a liquid crystal layer, a second polyimide alignment film, a common electrode, and a color filter (CF) substrate. When voltage is applied to the pixel electrode and the common electrode, an electric field is generated in the liquid crystal layer. The electric field determines orientation of liquid crystal molecules, and therefore adjusts polarization of incident light on the liquid crystal layer to produce pictures on the LCD panel display.

A manufacturing process of LCD panels generally includes a front-end array process (thin film, photolithography, etching and resistor stripping), a middle-end cell process (lamination of TFT substrate and CF substrate), and a back-end module assembly process (assembly of driving IC and printed circuit board). Wherein, the front-end array process mainly forms a TFT substrate to control motion of liquid crystal molecules. The middle-end cell process mainly provides a liquid crystal between the TFT substrate and the CF substrate and aligns the liquid crystal. The back-end module assembly process mainly assembles driving ICs and integrates printed circuit boards to drive the liquid crystal molecules to rotate and display pictures.

In particular, the middle-end cell process includes coating polyimide material respectively on an array substrate and a color filter substrate to form two PI alignment films; dropping liquid crystal molecules and coating sealant on the array substrate or the color filter substrate; correspondingly laminating the array substrate and the color filter substrate and curing the sealant to form LCD panels; performing photo alignment to the LCD panels by applying voltage and ultraviolet rays (UV) cooperatively to form a first PI alignment film and a second PI alignment film, and orienting the liquid crystal molecules regularly by the first PI alignment film and the second PI alignment film.

The middle-end cell process is complicated, and during the course of alignment, a heating plate is required to perform heat treatment to mother board of the array substrate. After heating the mother board of the array substrate, viscosity of the liquid crystal decreases and flow speed increases such that the liquid crystal is aligned and partial undesirable alignment is decreased. However, undesirable alignment of the liquid crystal cannot be completely overcome, which therefore leads to non-uniform display and an affected yield.

### SUMMARY OF INVENTION

The present invention provides a display panel and a manufacturing method for the display panel to overcome the technical problems of complicated processes, undesirable alignment, non-uniform display and affected yields in the conventional technology.

In order to realize the above mentioned purpose, the present invention provides a manufacturing method for a display panel including the following steps: a first substrate manufacturing step, dispensing a sealant layer on a lower surface of a first substrate; a second substrate manufacturing step, coating a liquid crystal layer on an upper surface of a second substrate; an assembling step, correspondingly assembling and laminating the first substrate and the second substrate; and a first alignment film layer manufacturing step, performing heat and light treatment to the first substrate to form a first alignment film layer; wherein the first substrate manufacturing step includes the following steps: a first underlying layer disposing step, disposing a first underlying layer; a common electrode layer manufacturing step, manufacturing a common electrode layer on an upper surface of the first underlying layer; and a first liquid crystal alignment monomer layer coating step, coating a liquid crystal alignment monomer material on an upper surface of the common electrode layer to form a first liquid crystal alignment monomer layer; wherein performing heat and light treatment to the first substrate will make a link reaction occur between the common electrode layer and the first liquid crystal alignment monomer layer and form the first alignment film layer.

Furthermore, in the first liquid crystal alignment monomer layer coating step, methods of coating include any one of spin coating, inkjet printing, slot die coating and nanoimprint lithography.

Furthermore, in the first alignment film layer manufacturing step, a heat gun is used to heat the first substrate and UV rays are used to perform light treatment to the first substrate.

Furthermore, the second substrate manufacturing step includes the following steps: a second underlying layer disposing step, disposing a second underlying layer; a pixel electrode layer manufacturing step, manufacturing a pixel electrode layer on an upper surface of the second underlying layer; a second alignment film layer manufacturing step, manufacturing a second alignment film layer on an upper surface of the pixel electrode layer; and a second liquid crystal alignment monomer layer coating step, coating a second liquid crystal alignment monomer layer on an upper surface of the second alignment film layer.

Furthermore, in the second alignment film layer manufacturing step, a layer of polyimide is coated on the upper surface of the second underlying layer to form the second alignment film layer.

Furthermore, in the second liquid crystal alignment monomer layer coating step, a liquid crystal alignment monomer material is coated on the upper surface of the second alignment film layer to form the second liquid crystal alignment monomer layer.

In order to realize the above mentioned purpose, the present invention further provides a display panel that includes a first substrate, a second substrate, a liquid crystal layer, and a sealant layer. The second substrate is disposed facing the first substrate, the liquid crystal layer is disposed between the first substrate and the second substrate, and the sealant layer is disposed between the first substrate and the second substrate and surrounds the liquid crystal layer. The first substrate includes a first underlying layer, a common electrode layer, and a first liquid crystal alignment monomer layer. The common electrode layer is disposed on one side surface of the first underlying layer, and the first liquid crystal alignment monomer layer is disposed on one side surface of the common electrode layer distant from the first underlying layer. The first liquid crystal alignment monomer layer occurs a link reaction with the common electrode layer to form a first alignment film layer.

Furthermore, the second substrate includes a second underlying layer, a pixel electrode layer, a second alignment film layer, and a second liquid crystal alignment monomer layer. The pixel electrode layer is disposed on one side surface of the second underlying layer, the second alignment film layer is disposed on one side surface of the pixel electrode layer distant from the second underlying layer, and the second liquid crystal alignment monomer layer is disposed on one side surface of the second alignment film layer distant from the pixel electrode layer.

Furthermore, the second alignment film layer is made of polyimide.

Furthermore, the first substrate is a color filter substrate and the second substrate is an array substrate.

The technical effect of the present invention is to provide a display panel and a manufacturing method for the display panel, which disposes a first liquid crystal alignment monomer layer on the surface of a common electrode layer, and uses a heat gun to perform heat and light treatment to a color filter substrate to make a link reaction occur between the first liquid crystal alignment monomer layer and the common electrode layer and form a first alignment film layer, and thereby undesirable alignment is improved and greyscale difference of a display panel caused by undesirable alignment is avoided to ensure yields and quality of products. Besides, when manufacturing a color filter substrate, the present invention cuts out a polyimide coating process, and cuts out a rubbing process to avoid drawbacks introduced therefrom, and further increases yields and increases competitiveness of products.

### DESCRIPTION OF DRAWINGS

The accompanying figures to be used in the description of embodiments of the present invention or prior art will be described in brief to more clearly illustrate the technical solutions of the embodiments or the prior art. The accompanying figures described below are only part of the embodiments of the present invention, from which figures those skilled in the art can derive further figures without making any inventive efforts.

FIG. 1 is a flowchart of a manufacturing method for a display panel according to the present invention.

FIG. 2 is a flowchart of a first substrate manufacturing step according to the present invention.

FIG. 3 is a flowchart of a second substrate manufacturing step according to the present invention.

FIG. 4 is a structural schematic diagram of a display panel according to the present invention.

Description of reference numerals:

| | |
|---|---|
| 1: first substrate | 2: second substrate |
| 3: liquid crystal layer | 4: sealant layer |
| 11: first underlying layer | 12: common electrode layer |
| 13: first alignment film layer | 14: first liquid crystal alignment |
| | monomer layer |
| 21: second underlying layer | 22: pixel electrode layer |
| 23: second alignment film layer | 24: second liquid crystal alignment |
| | monomer layer |
| 100: heat gun | |

### DETAILED DESCRIPTION OF PREFERRED EMBODIMENTS

The embodiments of the present invention are described in detail hereinafter. Examples of the described embodiments are given in the accompanying drawings. It should be noted that, the following embodiments are intended to illustrate and interpret the present invention, which shall not be construed as causing limitations to the present invention. Similarly, the following embodiments are part of the embodiments of the present invention and are not the whole embodiments, and all other embodiments those skilled in the art obtain without making any inventive efforts are within the scope protected by the present invention.

Terms such as “first”, “second”, etc. (if they exist) in the specification, claim and above-mentioned drawings of the present invention are used herein for purposes of description and are not intended to indicate or imply relative order or significance. It should be understood that elements described by such terms can be switched under proper conditions. Besides, terms such as “include”, “comprise” and any their variations are intended for a non-exclusive meaning.

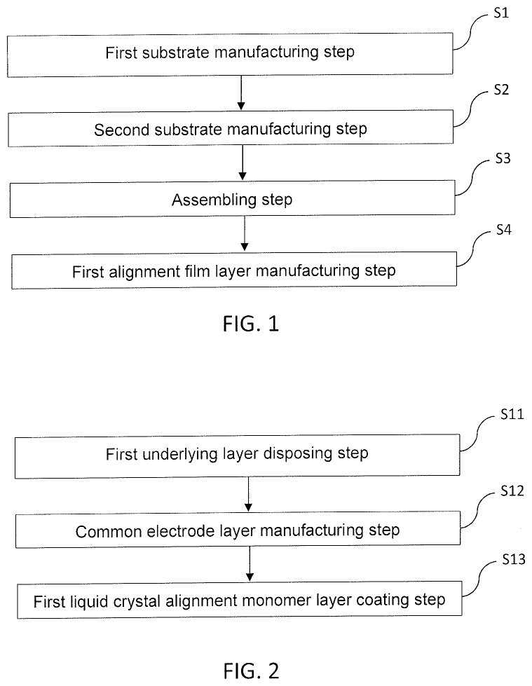

As shown in FIG. 1, the present embodiment provides a manufacturing method for a display panel including the following steps S1-S4.

S51, a first substrate manufacturing step, dispensing a sealant layer on an upper surface of a first substrate, wherein the first substrate is a color filter substrate. As shown in FIG. 2, the first substrate manufacturing step S1 includes the following steps S11-S13. S11, an underlying layer disposing step, disposing a first underlying layer. Making a black matrix and a color resist on the first underlying layer to form a color filter substrate. S12, a common electrode layer manufacturing step, manufacturing a common electrode layer on an upper surface of the first underlying layer. S13, a first liquid crystal alignment monomer layer coating step, coating a liquid crystal alignment monomer material on an upper surface of the common electrode layer to form a first liquid crystal alignment monomer layer. The methods of coating include any one of spin coating, inkjet printing, slot die coating, and nanoimprint lithography.

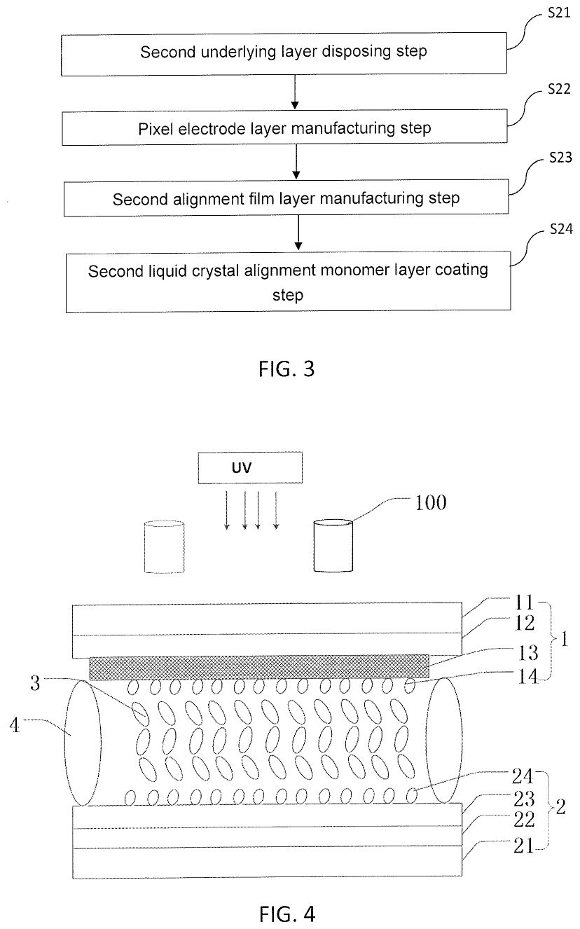

S2, a second substrate manufacturing step, coating a liquid crystal layer on an upper surface of a second substrate, wherein the second substrate is an array substrate. As shown in FIG. 3, the second substrate manufacturing step S2 includes the following steps S21-S24. S21, a second underlying layer disposing step, disposing a second underlying layer. Making scan lines, thin film field-effect transistors, and data lines on the second underlying layer to form an array substrate. S22, a pixel electrode layer manufacturing step, manufacturing a pixel electrode layer on an upper surface of the second underlying layer. S23, a second alignment film layer manufacturing step, manufacturing a second alignment film layer on an upper surface of the pixel electrode layer. In particular, coating a layer of polyimide on the upper surface of the second underlying layer to form the second alignment film layer. S24, a second liquid crystal alignment monomer layer coating step, coating a second liquid crystal alignment monomer layer on an upper surface of the second alignment film layer. In particular, coating a liquid crystal alignment monomer material on the upper surface of the second alignment film layer to form the second liquid crystal alignment monomer layer. The methods of coating include any one of spin coating, inkjet printing, slot die coating, and nanoimprint lithography.

S3, an assembling step, correspondingly assembling and laminating the first substrate and the second substrate.

S4, a first alignment film layer manufacturing step, performing heat and light treatment to the first substrate to form a first alignment film layer.

In the present embodiment, the order of the first substrate manufacturing step and the second substrate manufacturing step can be switched or performed simultaneously.

Under the condition of applying voltage, using a heat gun and UV rays to perform heat and light treatment to the first substrate to make a link reaction occur between the common electrode layer and the first liquid crystal alignment monomer layer and form a first alignment film layer, and using the first alignment film layer to orient liquid crystal molecules of the liquid crystal layer regularly, affecting the display effect of a display panel.

In particular, reactive monomer (RM) of the first liquid crystal alignment monomer layer gathers toward the common electrode layer when heated, making a link reaction occur between the liquid crystal alignment monomer layer and the common electrode layer under the effect of UV rays to form the alignment film layer.

In the present embodiment, a vertical electric field that drives the liquid crystal molecules to rotate is generated between the pixel electrode layer and the common electrode layer, and the heat gun is used to heat the first substrate. On the one hand, a polyimide layer disposed in a color filter substrate of the conventional technology can be removed to eliminate a polyimide coating process, and a rubbing process to avoid defects such as electrostatic charge, dust and abrasion introduced by an alignment film formed through rubbing. On the other hand, during the course of alignment, by using the heat gun to heat the second substrate, the liquid crystal molecules of the liquid crystal layer can be aligned uniformly to overcome the technical problem of undesirable alignment of the conventional technology, increasing yields and competitiveness of products.

Besides, during the course of alignment, because a second liquid crystal alignment monomer layer is disposed between the liquid crystal layer and the second substrate, under the condition of applying voltage, the liquid crystal monomer molecules of the second liquid crystal alignment monomer layer will gather toward the second alignment film layer and orient the liquid crystal molecules of the liquid crystal layer regularly, which therefore affects the display effect of the display panel.

As shown in FIG. 4, the present embodiment further provides a display panel including a first substrate 1, a second substrate 2, a liquid crystal layer 3, and a sealant layer 4. Wherein, the first substrate 1 is a color filter (CF) substrate, the second substrate 2 is a thin film transistor (TFT) array substrate, and the first substrate 1 and the second substrate 2 are disposed facing one another. The liquid crystal layer 3 is disposed between the first substrate 1 and the second substrate 2, and the sealant layer 4 is disposed between the first substrate 1 and the second substrate 2 and surrounds the liquid crystal layer 3.

In particular, the first substrate 1 includes a first underlying layer 11, a common electrode layer 12, a first liquid crystal alignment monomer layer 13, and a first alignment film layer 14.

The common electrode layer 12 is disposed on an upper surface of the first underlying layer 11, and the first liquid crystal alignment monomer layer 13 is disposed on an upper surface of the common electrode layer 12. Under the condition of applying voltage and ultraviolet rays (UV), using a heat gun 100 to heat the second substrate 2 will make a link reaction occur between the first liquid crystal alignment monomer layer 13 and the common electrode layer 12 and form the first alignment film layer 14.

The second substrate 2 includes a second underlying layer 21, a pixel electrode layer 22, a second alignment film layer 23, and a second liquid crystal alignment monomer layer 24.

The pixel electrode layer 22, the second alignment film layer 23, and the second liquid crystal alignment monomer layer 24 are disposed in order on an upper surface of the second underlying layer 21. The second alignment film layer 23 is made of polyimide, which is one of organic polymer materials.

In the present embodiment, under the condition of applying voltage, by using the heat gun and UV rays to perform heat and light treatment to the first substrate to make a link reaction occur between the common electrode layer and the first liquid crystal alignment monomer layer and form a first alignment film layer, and using the first alignment film layer to orient the liquid crystal molecules of the liquid crystal layer regularly, affecting the display effect of a display panel.

In particular, the reactive monomer of the first liquid crystal alignment monomer layer gathers toward the common electrode layer when heated, making a link reaction occur between the liquid crystal alignment monomer layer occurs a link reaction and the common electrode layer under the effect of UV rays to form the alignment film layer.

In the present embodiment, a vertical electric field that drives the liquid crystal molecules to rotate is generated between the pixel electrode layer and the common electrode layer, and the heat gun is used to heat the first substrate. On the one hand, a polyimide layer disposed in a color filter substrate of the conventional technology can be removed to eliminate a polyimide coating process, and a rubbing process, which prevent defects introduced therefrom. On the other hand, during the course of alignment, by using the heat gun to heat the second substrate, the liquid crystal molecules of the liquid crystal layer can be aligned uniformly to overcome the technical problem of undesirable alignment of the conventional technology, increasing yields and competitiveness of products.

Besides, during the course of alignment, because a second liquid crystal alignment monomer layer is disposed between the liquid crystal layer and the second substrate, under the condition of applying voltage, the liquid crystal monomer molecules of the second liquid crystal alignment monomer layer will gather toward the second alignment film layer and orient the liquid crystal molecules of the liquid crystal layer regularly, which therefore affects the display effect of a display panel.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A manufacturing method for a display panel comprising the following steps:
a first substrate manufacturing step, dispensing a sealant layer on a lower surface of a first substrate;
a second substrate manufacturing step, coating a liquid crystal layer on an upper surface of a second substrate;
an assembling step, correspondingly assembling and laminating the first substrate and the second substrate; and
a first alignment film layer manufacturing step, performing heat and light treatment to the first substrate to form a first alignment film layer;
wherein the first substrate manufacturing step comprises the following steps:
a first underlying layer disposing step, disposing a first underlying layer;
a common electrode layer manufacturing step, manufacturing a common electrode layer on an upper surface of the first underlying layer; and
a first liquid crystal alignment monomer layer coating step, coating a liquid crystal alignment monomer material on an upper surface of the common electrode layer to form a first liquid crystal alignment monomer layer;
wherein performing heat and light treatment to the first substrate will make a link reaction occur between the common electrode layer and the first liquid crystal alignment monomer layer and form the first alignment film layer.

2. The manufacturing method of a display panel as claimed in claim 1, wherein in the first liquid crystal alignment monomer layer coating step, methods of coating include any one of spin coating, inkjet printing, slot die coating, and nanoimprint lithography.

3. The manufacturing method of a display panel as claimed in claim 1, wherein in the first alignment film layer manufacturing step, a heat gun is used to heat the first substrate and UV rays are used to perform light treatment to the first substrate.

4. The manufacturing method of a display panel as claimed in claim 1, wherein the second substrate manufacturing step comprises the following steps:
a second underlying layer disposing step, disposing a second underlying layer;
a pixel electrode layer manufacturing step, manufacturing a pixel electrode layer on an upper surface of the second underlying layer;
a second alignment film layer manufacturing step, manufacturing a second alignment film layer on an upper surface of the pixel electrode layer; and
a second liquid crystal alignment monomer layer coating step, coating a second liquid crystal alignment monomer layer on an upper surface of the second alignment film layer.

5. The manufacturing method of a display panel as claimed in claim 4, wherein in the second alignment film layer manufacturing step, a layer of polyimide is coated on the upper surface of the second underlying layer to form the second alignment film layer.

6. The manufacturing method of a display panel as claimed in claim 4, wherein in the second liquid crystal alignment monomer layer coating step, a liquid crystal alignment monomer material is coated on the upper surface of the second alignment film layer to form the second liquid crystal alignment monomer layer.

7. A display panel comprising:
a first substrate;
a second substrate disposed facing the first substrate;
a liquid crystal layer disposed between the first substrate and the second substrate; and
a sealant layer disposed between the first substrate and the second substrate, and surrounding the liquid crystal layer;
wherein the first substrate comprises:
a first underlying layer;
a common electrode layer disposed on one side surface of the first underlying layer; and
a first liquid crystal alignment monomer layer disposed on one side surface of the common electrode layer distant from the first underlying layer;
wherein the first liquid crystal alignment monomer layer occurs a link reaction with the common electrode layer to form a first alignment film layer.

8. The display panel as claimed in claim 7, wherein the second substrate comprises:
a second underlying layer;
a pixel electrode layer disposed on one side surface of the second underlying layer;
a second alignment film layer disposed on one side surface of the pixel electrode layer distant from the second underlying layer; and
a second liquid crystal alignment monomer layer disposed on one side surface of the second alignment film layer distant from the pixel electrode layer.

9. The display panel as claimed in claim 8, wherein the second alignment film layer is made of polyimide.

10. The display panel as claimed in claim 7, wherein the first substrate is a color filter substrate, and the second substrate is an array substrate.
